(19) United States
(12) Patent Application Publication
(10) Pub. No.: US 2007/0194565 A1
(43) Pub. Date: Aug. 23, 2007

(54) Device for and a method of controlling tension of a vehicle seatbelt

(75) Inventor: Gunter K. Clute, Bloomfield Hills, MI (US)

Correspondence Address: AUTOLIV ASP, 3350 AIRORT ROAD, OGDEN, UT, 84405, US

(73) Assignee: Autoliv ASP, Inc.

(21) Appl. No.: 11/358,310

(22) Filed: Feb. 21, 2006

(51) Int. Cl. B60R 22/00; B65H 75/48

(52) U.S. Cl. 280/806; 280/801.1; 242/390; 297/476

(57) ABSTRACT

Devices and methods for controlling tension in a vehicle seatbelt are provided. The device includes a seatbelt positioning device coupled with the seatbelt so that movement of the seatbelt positioning device retracts or protracts the seatbelt, a motor coupled with the seatbelt positioning device such that rotation of the motor protracts a portion of the seatbelt, a measurement device for measuring a system input, and a controller coupled with the measurement device and with the motor such as to receive the system input and to protract a portion of the seatbelt when the system input reaches a maximum desired level.

### BACKGROUND

1. Field of the Invention

The present invention relates to systems and methods for controlling seatbelt tension of motor vehicle safety systems. More specifically, the invention relates to devices for and methods of controlling tension in a seatbelt during various stages of a vehicle impact event.

2. Related Technology

Seatbelt restraint systems for automobiles include a locking mechanism to prevent the seat occupant from traveling forward during particular stages of vehicle operation. For example, in one design, the locking mechanism is typically actuated to prevent the seat occupant from forward travel. In another design, the seatbelt restraint system may include a selectively-locking mechanism that only restricts the seat occupant's forward travel during various stages of a vehicle impact event, such as during a vehicle impact or a pre-impact. This design, which is currently utilized in most vehicles, permits the occupant to have a certain degree of freedom of movement during normal driving conditions.

In both of the above-described locking mechanism designs the vehicle occupant is restrained during a vehicle impact event, thereby generating relatively high belt loads between the seatbelt and the vehicle occupant. As the vehicle impact progresses and the occupant moves forward in the seat, the belt loads may become undesirably high. For example, an undesirably high seatbelt load may cause localized injuries to the occupant along the points of contact between the occupant and the seatbelt. Therefore, it may be desirable to provide a load limiting device to limit the maximum loads exerted on the occupant.

Furthermore, as the vehicle impact progresses and the occupant moves forward in the seat, the occupant may also be restrained for an undesirable duration of time or over an undesirable distance of travel. More specifically, during or after the vehicle impact, the occupant may reach a point where a reduced or minimal seatbelt tension is desirable. For example, it is often desirable to loosen or release the seatbelt as the occupant contacts a deployed airbag so as to permit the airbag to control the occupant's forward movement. Therefore, it may be desirable to provide a device that limits the duration of time or the distance of travel over which the seatbelt restrains the occupant.

Seatbelt restraint systems often include a pretensioner as part of a seatbelt retractor which applies tension to the seatbelt when a vehicle impact or a potential vehicle impact is detected. Pretensioners typically operate by retracting the seatbelt slack in a relatively fast manner and then preventing forward movement of the seatbelt to restrain the vehicle occupant. Therefore, when activated, the pretensioner eliminates slack in the seatbelt and controls the physical space between the occupant and the seatbelt. In this manner, less slack is present in the seatbelt, thereby controllably restraining the occupant, reducing occupant movement, and controlling loads when the occupant moves forwardly into engagement with the seatbelt.

Currently-known pretensioners utilize a fast-actuating mechanism, such as a pyrotechnic device or a solenoid. However, these mechanisms are typically not automatically reversible or reusable. For example, once the solenoid or pyrotechnic device has been actuated, it typically must be manually reset before it is able to actuate again.

While current safety restraint devices achieve their intended purpose, many enhancements and additional features are needed. Therefore, a new and improved pretensioning system and method for controlling tension of a vehicle seatbelt would be desirable.

### SUMMARY

In overcoming the limitations and drawbacks of the prior art, the present invention provides devices for and methods of controlling tension in a vehicle seatbelt.

In one aspect of the invention, the device generally includes: a seatbelt positioning device coupled with the seatbelt so that movement of the seatbelt positioning device retracts or protracts the seatbelt, a motor coupled with the seatbelt positioning device such that rotation of the motor protracts a portion of the seatbelt, a measurement device for measuring a system input, and a controller coupled with the measurement device and with the motor such as to receive the system input and protract a portion of the seatbelt when the system input reaches a maximum desired level.

The seatbelt positioning device is preferably a pulley coupled with the seatbelt such that the rotation of the motor in the protraction direction protracts a portion of the seatbelt from the pulley. Alternatively, the seatbelt positioning device is preferably a seatbelt buckle coupled with the seatbelt such that the rotation of the motor in the protraction direction protracts the seatbelt buckle and a portion of the seatbelt away from the motor.

In one design of the invention, the measurement device is a load sensor and the system input is a belt load acting on the seatbelt. In this design, the device acts as a load limiter to prevent the vehicle occupant from experiencing undesirably high seatbelt loads.

In another design, the measurement device is a timer and the system input is an elapsed time after an impact event is detected. This device limits the duration of time over which the seatbelt restrains the occupant to prevent the vehicle occupant from being undesirably restrained during the late stages of an impact event.

The device may also include a tension limiting device selectively coupling the motor with the pulley. The tension limiting device is configured to decouple the motor and the pulley from each other when a belt load acting on the seatbelt reaches a critical level. Therefore, even if the motor and the controller are unable to sufficiently control the belt load between the occupant and the seatbelt, the tension limiting device is able to do so. In one exemplary design, the tension limiting device includes a torsion bar having a first end coupled with the motor and a second end coupled with the pulley. The torsion bar has a torsional yield limit corresponding to the critical belt load level so that the torsion bar yields at or near the critical belt load level and limits the belt loads acting on the occupant.

In another exemplary design, the tension limiting device includes a friction-based load limiter having a first portion coupled with the motor and a second portion coupled with the pulley. The first and second portions are configured to engage each other and to selectively couple the motor and the pulley with each other via a frictional force. For example engaging surfaces of the respective portions are frictionally engaged with each other so that relative movement therebetween is only permitted when the belt load reaches a critical level.

The device may be used for pre-pretensioning and/or pretensioning the seatbelt. For example, the controller may be configured to rotate the motor in the retraction direction when an impact event is predicted or detected. More specifically, pre-pretensioning occurs when an impact event is predicted and the controller causes the retraction of a relatively small length of the seatbelt webbing with a relatively low retraction force. Additionally, pretensioning occurs when an impact event is detected and the controller causes the retraction of a longer length of the seatbelt webbing with a higher retraction force. Additionally, the device may include an impact sensor and/or an acceleration sensor electrically connected with the controller to predict or detect the impact event.

In another aspect of the invention, the device generally includes: a seatbelt positioning device coupled with the seatbelt so that movement of the seatbelt positioning device retracts or protracts the seatbelt, a first tension controlling device configured to move the seatbelt positioning device in a protraction direction when a system input reaches a maximum desired level, and a second tension controlling device selectively coupling the first tension controlling device with the seatbelt positioning device. The second tension controlling device is configured to decouple the first tension controlling device and the seatbelt positioning device from each other when a belt load acting on the seatbelt reaches a critical level.

In one design, the first tension controlling device includes a motor coupled with the pulley and a controller electrically connected to the motor. The controller and the motor cooperate to rotate the pulley in the protraction direction when the system input reaches the maximum desired level.

In yet another aspect of the present invention, a method of controlling tension of a vehicle seatbelt generally includes: coupling a pulley with the seatbelt so that rotation of the pulley moves the seatbelt, coupling a motor with the pulley so rotation of the motor in a protraction direction protracts the seatbelt from the pulley, and controlling the motor with a controller. The controller rotates the motor in the protraction direction and protracts a portion of the seatbelt from the pulley when a system input reaches a maximum desired level.

In one design, the method further includes the step of selectively coupling the motor and the pulley with each other with a tension limiting device. The motor and the pulley are selectively decoupled from each other when a tension acting on the seatbelt reaches a critical belt load level. For example, the step may include coupling a first end of a torsion bar with the motor and coupling a second end of the torsion bar with the pulley.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a perspective view of a vehicle seat and a seatbelt assembly coupled with each other;

FIG. 2 is a cross-sectional view of a seatbelt retractor embodying the principles of the present invention and being coupled with the seatbelt assembly shown in FIG. 1;

FIG. 3 is a graph depicting an exemplary seatbelt load versus time for the seatbelt retractor shown in FIG. 2;

FIG. 4 is a cross-sectional view of another alternative embodiment of a seatbelt retractor embodying the principles of the present invention; and

FIG. 5 is a cross-sectional view of yet another alternative embodiment of a seatbelt retractor embodying the principles of the present invention.

### DETAILED DESCRIPTION

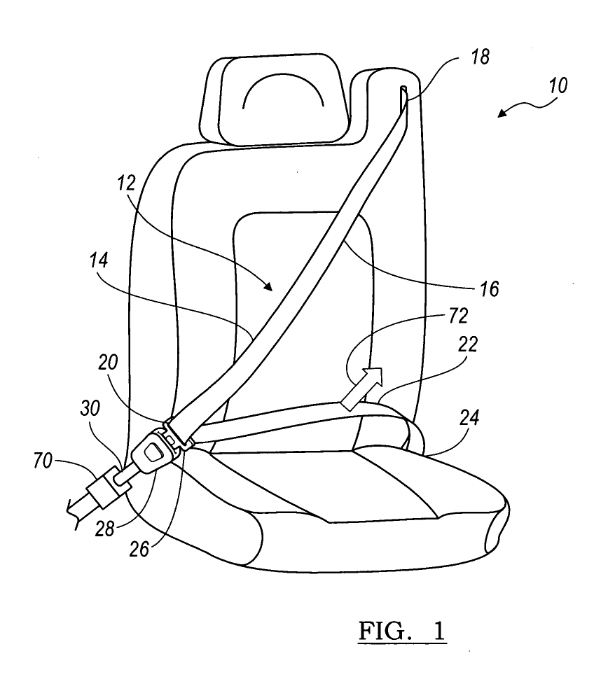

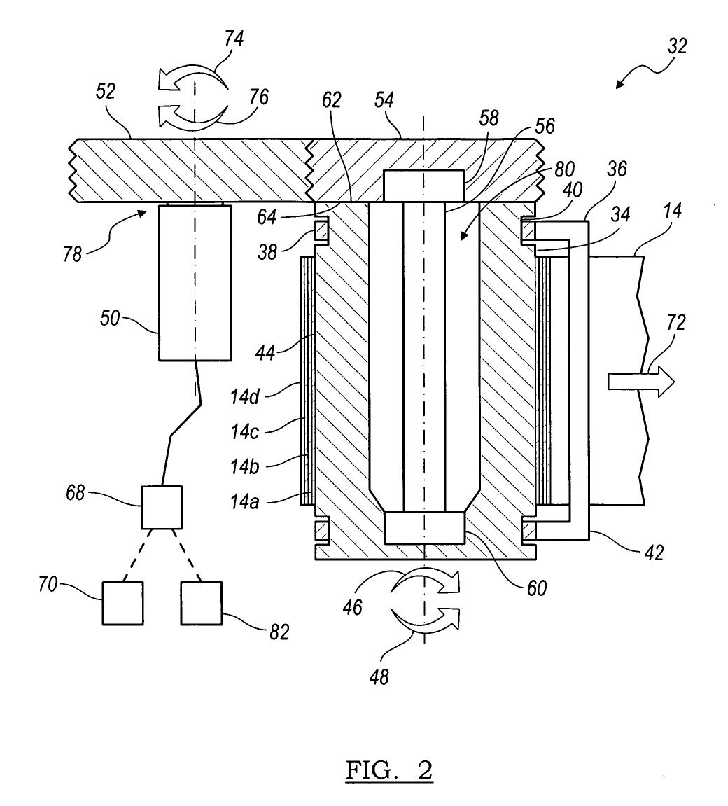

Referring now to the drawings, FIG. 1 shows a vehicle seat 10 and a seatbelt assembly 12. The seatbelt assembly 12 includes a seatbelt webbing 14 having a shoulder belt portion 16 extending from an upper anchorage 18 to a buckle loop 20 and a lap belt portion 22 extending from the buckle loop 20 to an anchor point 24. A buckle latch plate 26 is able to be inserted into a seatbelt buckle 28 to lock and unlock the seatbelt assembly 12. A seatbelt buckle cable 30, either directly or in cooperation with other components, secures the seatbelt buckle 28 to a portion of the vehicle frame. The seatbelt webbing 14 is able to pay-out from a device for controlling tension of the seatbelt assembly 12, such as a retractor 32 (FIG. 2), which is located within the vehicle seat 10 (in an integrated structural seat design) or is coupled with a fixed point of the vehicle body, so that the effective length of the seatbelt webbing 14 is adjustable. When the buckle latch plate 26 has been inserted into the seatbelt buckle 28, the seatbelt assembly 12 defines a three-point contact between the upper anchorage 18, the buckle latch plate 26, and the anchor point 24. Any other suitable configurations, such as alternative locations for the retractor 32, the buckle latch plate 26, and the anchor point 24, may be used with the present invention.

During normal operation of the vehicle, the retractor 32 allows pay-out of seatbelt webbing 14 to give the occupant a certain amount of freedom of movement. Due in part to the free pay-out of the seatbelt webbing 14, the seatbelt assembly 12 often develops slack during normal operation. However, if an impact or a potential impact situation is detected, the retractor is locked to prevent pay-out and to secure the occupant in the vehicle seat 10. For example, if the vehicle decelerates at a predetermined rate or if the brakes are actuated with a predetermined force then the retractor 32 is locked, as will be discussed in further details below.

Referring to FIG. 2, the retractor 32 includes a seatbelt positioning device, such as a pulley 34, for controlling the movement of the seatbelt webbing 14. More specifically, the retractor 32 controls the amount of slack in the seatbelt assembly 12 by retracting or protracting the seatbelt webbing 14.

The pulley 34 is rotatably coupled with the vehicle seat 10 within the upper anchorage 18 of the vehicle seat 10 via a frame 36 so that the pulley 34 can be rotated with respect to the frame 36 and the vehicle seat 10. The frame includes ring portions 38 having a relatively low friction surface and encircling the pulley 34 such that the respective components 34, 36 are rotatable with each other. Alternatively, the pulley 34 and the frame 36 may be coupled via a bushing assembly (not shown). The pulley 34 also includes a pair of notched portions 40 for receiving and laterally securing the ring portions 38. The frame 36 also includes a securing portion 42 that connects to the vehicle seat 10.

In an alternative configuration, the retractor 32 is coupled with a portion of the vehicle frame (not shown) adjacent to the vehicle seat 10, such as in the location of the anchor point 24 in FIG. 1 or a location adjacent to the upper anchorage 18 of the vehicle seat 10.

The pulley 34 also includes a winding surface 44 that is connected with a portion of the seatbelt webbing 14 so that the seatbelt webbing 14 is wound around the winding surface 44 as the pulley 34 rotates in a retraction direction 46 and is unwound from the winding surface 44 as the pulley 34 rotates in a protraction direction 48. Therefore, as the pulley 34 rotates in the retraction direction 46 the number of layers 14a, 14b, 14c, 14d of seatbelt webbing 14 that encircle the winding surface 44 increases, thereby reducing the length of the seatbelt webbing 14 available for the vehicle occupant and potentially tightening any slack in the seatbelt assembly 12. Conversely, as the pulley 34 rotates in the protraction direction 48 the number of layers 14a, 14b, 14c, 14d of seatbelt webbing 14 that encircle the winding surface 44 decreases, thereby increasing the length of the seatbelt webbing 14 available for the vehicle occupant and potentially increasing any slack in the seatbelt assembly 12.

An end of the seatbelt webbing 14 may be connected to the winding surface 44 by any appropriate configuration, such as an adhesive bonding or a fastener. In another suitable design, the seatbelt webbing 14 may be formed into a loop which is tightly wound around the winding surface 44. The frame 36 serves as a guide for the seatbelt webbing 14 to generally stack the layers 14a, 14b, 14c, 14d upon each other.

The pulley 34 is coupled with an electric motor 50 so that the respective components 34, 50 rotate with each other in opposite directions. For example, the motor 50 is connected to a driving gear 52, which meshes with and drives a driven gear 54. The driven gear 54 is coupled with the pulley 34 via a tension limiting device, such as a torsion bar 56. More specifically, the torsion bar 56 has a first end 58 connected to the driven gear 54 and a second end 60 connected to the pulley 34 so that the rotational torque from the driven gear 54 is transmitted to the pulley 34, as will be discussed in more detail below. Additionally, a pulley contact surface 62 and a driven gear contact surface 64 engage each other so that at a portion of the rotational torque of the driven gear 54 is directly transmitted to the pulley 34. For example, frictional forces between the respective contact surfaces 62, 64 may be strong enough to cause the respective contact surfaces 62, 64 to rotate together, depending on the magnitude of rotational forces from the seatbelt webbing 14 acting on the pulley 34.

As shown in FIG. 2, the torsion bar 56 extends through a central cavity 66 to avoid interfering with the wrapping of the seatbelt webbing 14. However, any other suitable configuration may be used. The torsion bar 56 is preferably a generally cylindrical member made of a relatively strong material, such as steel or aluminum, and preferably includes enlarged diameter portions at the first and second ends 58, 60, respectively. However, any other suitable configuration may be used, such as a torsion bar with a uniform diameter. The torsion bar 56 shown in the figures is a single, unitary component, but in an alternative design the first and second ends 58, 60 are separate components that are integrally connected to a central member. The torsion bar 56 may also include notches, flat spots, or other anti-rotation shapes on the first and second ends 58, 60 to improve the connections with the driven gear 54 and the pulley 34.

The design specifications for the torsion bar 56 (material type, length, and diameter) may be varied to achieve a desired torsional stiffness and a desired torsional yield limit. For example, a particular torsional stiffness will dictate the extent that the torsion segment is able elastically twist, and therefore the extent that the coupled components 34, 54 are able to rotate with respect to each other. The above design specifications also affect the torsional yield limit of the torsion bar 56, thereby dictating the torsional load at which the torsion bar 56 will plastically deform and act as a load reducer, as will be discussed in more detail below.

The retractor 32 shown in the figures also includes a controller 68 in electrically connection with the motor 50 to control the rotation thereof. Furthermore, the retractor 32 includes a measurement device, such as a load sensor 70 (FIGS. 1 & 2), for measuring a system input, such as a belt load 72 (FIGS. 1 & 2) acting on the seatbelt assembly 12. The controller 68 and the load sensor 70 are electrically connected via a suitable connection, such as an electrical connector wire or a wireless configuration having a transmitter and a receiver. Thus, the controller 68 is configured to receive a signal from the load sensor 70 and to accordingly rotate the motor 60 in a retraction direction 74 or a protraction direction 76 as desired, as will be discussed in more detail below. As mentioned above, due to the configuration of the respective driving and driven gears 52, 54 shown in the figures, the retraction direction 46 of the pulley 34 is opposite from the retraction direction 74 of the motor 50 and the protraction direction 48 is opposite from the protraction direction 76 of the motor 50.

The controller 68, the motor 50, and the respective gears 52, 54 cooperate to define an active tension controlling device 78. More specifically, when the belt load 72 reaches a maximum desired level, the active tension controlling device 78 rotates the pulley 34 in the protraction direction 48 to protract a portion of the seatbelt webbing 14 and to lower the belt load 72 acting on the seatbelt assembly 12 by the vehicle occupant. In one design, the maximum desired level of the belt load 72 is a variable value based on different variables, such as the occupant's weight, the amount of seatbelt webbing 14 that is initially extended from the retractor 32, the vehicle speed, the vehicle deceleration, and any other appropriate variable. These variables may be measured by respective vehicle sensors, such as a seat load sensor, a rotational displacement sensor coupled with the pulley 34, a speedometer, and an accelerometer. Alternatively, the maximum desired level of the belt load 72 is a predetermined, constant value. In both of the above designs, the maximum desired level of the belt load 72 is preferably determined such that the occupant's potential injury from the belt load 72 is considered with respect to the occupant's potential injury from a collision with other vehicle components, such as the steering wheel or the dashboard.

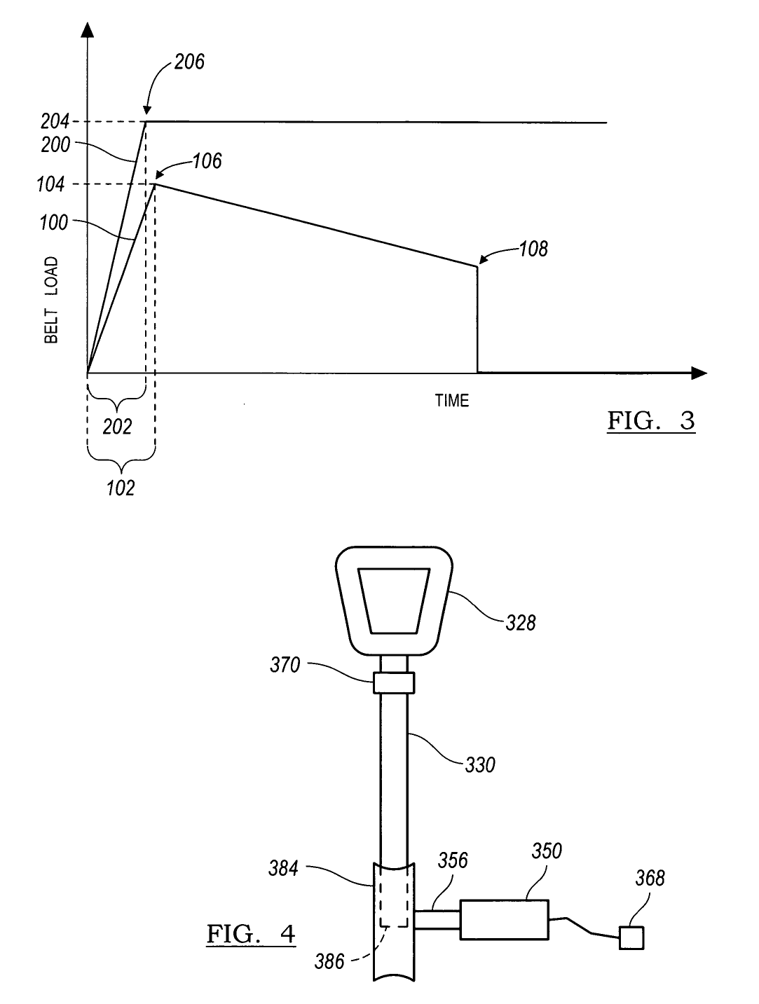

Referring to FIG. 3, the active tension controlling device 78 will now be discussed in more detail. FIG. 3 shows a first function, generally indicated by numeral 100 representing a belt load acting on the seatbelt assembly 12 when the active tension controlling device 78 is operational. During a first time period 102, the vehicle is undergoing an impact event and the belt load is increasing at rate generally equal to the slope of the first function 100 over the first time period 102. Then, once the belt load reaches the maximum desired level 104, the controller rotates the motor 50 in the protraction direction 76 to reduce the seat belt load. More specifically, the controller is rotating at such a speed so that the belt load decreases steadily over time between points 106 and 108. Then, after a desired time period has passed, at point 108, the speed of the motor 50 to decrease the seat belt load to approximately zero. More specifically, the motor is protracted at a rate equal to or greater than the occupant's rate of forward movement at point 108, thereby reducing seat belt load to zero. This exemplary embodiment may be particularly desirable to dramatically reduce the seat belt load just before the occupant impacts the deployed air bag.

The controller may be programmed to protract in any other suitable fashion, such as to maintain a relatively constant belt load on the occupant during the crash, or to permit a progressive belt load rather than the degressive load shown in FIG. 3. However, the progressive belt load preferably has a more gradual slope than that of the first function 100 so that the occupant is not subject to relatively high acceleration or deceleration. Therefore, the controller is able to gradually reduce the belt load and potentially provide a smoother, less abrupt deceleration of the occupant's forward travel.

As shown in FIG. 2, the torsion bar 56 defines a passive tension controlling device 80 configured to decouple the first tension controlling device 78 and the pulley from each other when the belt load 72 acting on the seatbelt assembly 12 reaches a critical level. For example, as the belt load 72 reaches a critical level the torsion bar 56 begins to plastically deform and permit protraction of the seatbelt webbing 14. Therefore, if the controller 68 and/or the motor 50 fail to sufficiently maintain the belt load 72 at or below the maximum desired level 104, the torsion bar 56 may potentially still limit the maximum belt load 72 at or below the critical level.

Referring back to FIG. 3, the passive tension controlling device 80 will now be discussed in more detail. FIG. 3 shows a second function, generally indicated by numeral 200 depicting a belt load acting on the seatbelt assembly 12 when the active tension controlling device 78 is not operational. During a first time period 202, the vehicle is undergoing an impact event and the belt load is increasing at rate generally equal to the slope of the second function 200 over the first time period 202. The belt load rate of change of the second function 200 in FIG. 3 is greater than the belt load rate of change of the first function 100 in FIG. 3 for illustrative purposes so that the respective functions 100, 200 do not overlap. When the belt load reaches the critical level 204, at point 206, the torsion bar 56 begins to plastically deform and cause the belt load to level out, thereby limiting the load transferred between the driven gear 54 and the pulley 34 and effectively limiting the load transferred to the seatbelt assembly 12.

The passive tension controlling device 80 is especially desirable because it provides a load limiting function that can limit the belt load 72 regardless of whether the active tension controlling device 78 is present and/or operational. Therefore, the passive tension controlling device 80 can serve as a redundant back-up system to the active tension controlling device 78 or as a replacement for at least some of the functions of the active tension controlling device 78.

The critical level is preferably greater than or equal to the maximum desired value so that the torsion bar 56 does not plastically deform until the system input exceeds the maximum desired value. In one exemplary situation, the system input may exceed the maximum desired value if the active tension controlling device 78 fails to operate properly. In another exemplary situation, the system input may exceed the maximum desired value if the active tension controlling device 78 is operating properly but is unable to protract seatbelt webbing 14 quickly enough to maintain the system input at or below the maximum desired value. Similarly to the maximum desired value, the critical value may be a predetermined constant value or it may have a variable value.

The seatbelt assembly 12 may have a buckle presenting function for adjustably positioning the seatbelt buckle 28 in a position that is convenient for the occupant. More specifically, when the occupant is entering or leaving the vehicle, the seatbelt buckle 28 is raised towards the occupant so that the seatbelt buckle 28 is relatively easily accessible. Then, when the occupant is not entering or leaving the vehicle, the seatbelt buckle 28 is lowered downward to slightly tighten the slack on the seatbelt webbing 14 and to move the seatbelt buckle 28 away from the occupant's immediate area. The process of raising the seatbelt buckle 28, which is generally referred to as buckle presenting, typically occurs at a relatively low speed with a relatively low motor torque. For example, an electric motor (not shown) having a relatively low torque and/or a relatively low rotations per minute (RPM) is coupled with the seatbelt buckle cable 30 to move the seatbelt buckle 28 upwards or downwards as desired.

An exemplary operation of the seatbelt assembly 12 will now be discussed in more detail.

During normal driving conditions, the seatbelt positioning device controls the slack of the seatbelt webbing 14. For example, the controller 68 may cause the motor 50 to apply a constant retraction force on the seatbelt webbing 14 to reduce slack during normal driving conditions. The retraction force is preferably small enough so that the occupant is able to easily protract the seatbelt webbing 14 by pulling thereon or by merely moving around. Under this configuration, slack may be reduced while the occupant retains some freedom of mobility.

When an impact event is detected by the controller, the motor 50 causes the pulley 34 to rotate in the retraction direction 46 to quickly reduce slack in the seatbelt assembly 12, preferably before the vehicle impact occurs. This function, known as pretensioning, reduces or eliminates seatbelt slack in a relatively fast manner and then prevents forward movement of the seatbelt to restrain the vehicle occupant. Therefore, when the pretensioning function is activated, the retractor 32 eliminates slack in the seatbelt and controls the physical space between the occupant and the seatbelt. In this manner, less slack is present in the seatbelt assembly 12, thereby controllably restraining the occupant and reducing occupant movement.

The above-mentioned impact event may be any appropriate type of impact event, such as an actual vehicle impact, a predicted impact, or an event that potentially creates an increased risk of an impact. The controller 68 may be configured to detect these types of impact events by any sensing any appropriate condition, such as an acceleration of the pulley 32 having a particular magnitude, a belt load 72 having a particular magnitude, a vehicle deceleration having a particular magnitude, an application of the vehicle brakes having a particular magnitude, a rotation of the vehicle steering wheel having a particular rotational velocity and/or angular displacement, or the displacement or destruction of an impact sensor positioned on the vehicle body. The controller 68 may be in electrical communication with any appropriate sensor, such as a pulley accelerometer, the load sensor 70, a vehicle accelerometer, a brake load sensor, a steering wheel sensor, or an impact sensor.

As another example, the above described system input may be a length of seatbelt webbing 14 that is deployed from the pulley 34. In this design, the pulley 34 is protracted after the predetermined length of seatbelt webbing 14 has been deployed from the pulley 34 to prevent the vehicle occupant from being undesirably restrained during the late stages of an impact event. For example, once enough seatbelt webbing 14 has been deployed to permit the occupant to contact a deployed airbag, it may be desirable to loosen or release the seatbelt assembly 12.

Once the actual impact occurs and the occupant is urged forward into the seatbelt assembly 12, the seatbelt load 72 and the load acting on the motor 50 drastically increase. Therefore, because the motor 50 and the respective gears 52, 54 experience this relatively high seatbelt load 72, these components 52, 54 are preferably made of relatively strong materials such as steel or aluminum.

Next, as shown in FIG. 3 and discussed above, the active tension controlling device 78 and/or the passive controlling device 80 control the magnitude of the seatbelt load 72 acting on the seatbelt assembly 12. The load experienced by the torsion bar 56 is related to the rotation of the motor 50. For example, in one extreme end of the spectrum, if the motor 50 has no rotation during the vehicle impact then the torsion bar 56 will experience the entire load of the vehicle occupant's forward movement. Conversely, at the other end of the spectrum, if the motor 50 has a very high rotation speed during the vehicle impact then the vehicle occupant will experience little or no restraint from the seatbelt assembly 12 and the torsion bar 56 will experience little or no load. However, the controller is preferably configured such that the motor speed is somewhere in between the two above examples and such that the vehicle occupant is restrained at or near the maximum desired level.

As a design alternative, other types of actuators may be used with the active tension controlling device 78 in lieu of the electric motor 50. For example, a pyrotechnic-based system may be used to protract the pulley 34 when the controller 68 determines that such action is desirable. As another example, a solenoid-based system may also be used to protract the pulley 34 when desired. As yet another example, the actuator may be a composite system including any of the above-described components combined with each other and/or other suitable components.

As another design alternative, other types of system inputs may be received by the controller 68 for determining whether it is desirable to protract the pulley 34. For example, the system input may be a predetermined elapsed amount of time after an impact event is detected and the measurement device may be a timer 82 that is electrically connected to the controller 68. In this design, the pulley 34 is protracted after the predetermined elapsed amount of time to prevent the vehicle occupant from being undesirably restrained during the late stages of an impact event. For example, once the occupant contacts a deployed airbag or once the impact events have ceased and it is safe to exit the vehicle, it may be desirable to loosen or release the seatbelt assembly 12.

Referring to FIG. 4, another embodiment of the present invention is shown, where a seatbelt buckle 328 and a seatbelt buckle cable 330 cooperate to define the seatbelt positioning device. In this design, the motor 350 controls the transverse displacement of the seatbelt buckle cable 330 to thereby tighten or loosen the slack of the seatbelt webbing when the seatbelt latch plate is received by the seatbelt buckle cable 330. For example, the seatbelt buckle cable 330 is wrapped around a pulley 384 to control the position of the seatbelt buckle 328. More specifically, an end portion 386 of the seatbelt buckle cable 330 is fastened or otherwise connected to the pulley 384 to prevent the respective components 330, 384 from becoming disconnected from each other and to permit the buckle cable 330 to wrap around or unwrap from the pulley 384 depending on the rotational direction thereof. In an alternative design, the seatbelt cable is connected to a generally rigid plate having gear receiving slots or protrusions, and the motor is connected to a rotatable gear having gear teeth that contact the slots or protrusions and cause the translational movement of the plate.

The motor 350 is controlled by a controller 368 that cooperates with the motor 350 to define an active tension controlling device similar to that described above. The controller 386 is also preferably electrically connected to a load sensor 370 or another appropriate device for measuring a system input. Additionally, the motor 350 and the pulley 384 are coupled via a torsion bar 356 that acts as a passive tension controlling device similar to that described above.

The embodiment shown in FIG. 4 may have some advantages over the design shown in FIG. 2. For example, the embodiment shown in FIG. 4 is able to perform the buckle presenting functions described above by utilizing the controller 368 and the motor 350 rather than requiring additional components. Furthermore, the position of the device shown in FIG. 4 with respect to the vehicle seat may be advantageous because it is able to tighten slack from a point closer to the middle point of the seatbelt webbing rather than from an endpoint, thereby potentially more evenly reducing the belt load along the length of the seatbelt webbing.

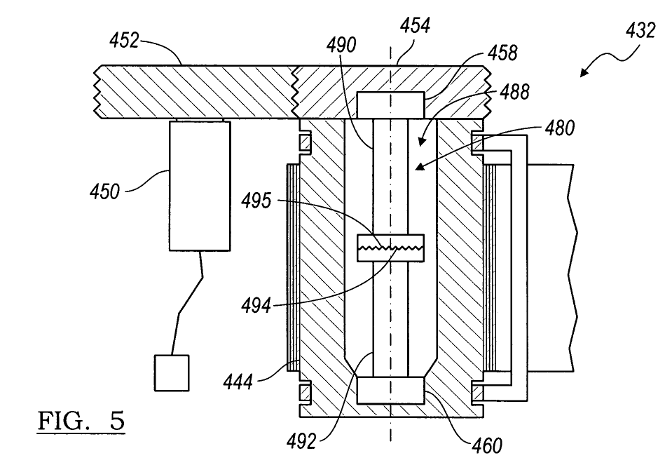

Referring to FIG. 5, another embodiment of the present invention is shown, where the passive active tension controlling device 480 is a friction-based load limiter 488 including: a first portion 490 that is coupled with a motor 450 via a pair of gears 452, 454 and that defines a first engagement surface 494, and a second portion 492 that is coupled with a pulley 444 and that defines a second engagement surface 495 that is configured to engage the first engagement surface 494 to selectively couple the motor 450 and the pulley 444 with each other. More specifically, the respective engagement surfaces 494, 495 preferably are generally rough surfaces so as to create a relatively strong frictional force resisting relative movement therebetween. Therefore, during relatively small belt loads that are less than a critical level, the two portions 490, 492 rotate in unison and cause the motor 450 and the pulley 444 to do the same. However, during relatively large belt loads approaching the critical level, the respective engagement surfaces 494, 495 slip with respect to each other and the motor 450 and the pulley 444 no longer move in unison; thereby limiting the belt load.

It is therefore intended that the foregoing detailed description be regarded as illustrative rather than limiting, and that it be understood that it is the following claims, including all equivalents, that are intended to define the spirit and scope of this invention.

What is claimed is:

1. A device for controlling tension of a vehicle seatbelt that is coupled with a vehicle seat, the device comprising:
a seatbelt positioning device coupled with the seatbelt such that movement of the seatbelt positioning device moves at least a portion of the seatbelt with respect to the vehicle seat;
a motor coupled with the seatbelt positioning device such that rotation of the motor in a protraction direction protracts the portion of the seatbelt with respect to the vehicle seat;
a measurement device for measuring a system input; and
a controller coupled with the measurement device such as to receive the system input and coupled with the motor such as to rotate the motor in the protraction direction to protract the portion of the seatbelt with respect to the vehicle seat when the system input reaches a maximum desired level.

2. A device as in claim 1, wherein the seatbelt positioning device is a pulley coupled with the seatbelt such that the rotation of the motor in the protraction direction protracts the portion of the seatbelt from the pulley.

3. A device as in claim 2, further comprising a tension limiting device selectively coupling the motor with the pulley, wherein the tension limiting device is configured to decouple the motor and the pulley from each other when a belt load acting on the seatbelt reaches a critical level.

4. A device as in claim 3, wherein the tension limiting device includes a torsion bar having a first end coupled with the motor and a second end coupled with the pulley, and wherein the torsion bar has a torsional yield limit corresponding to the critical belt load level.

5. A device as in claim 3, wherein the tension limiting device includes a friction-based load limiter including:
a first portion coupled with the motor and defining a first engagement surface;
a second portion coupled with the pulley and defining a second engagement surface that is configured to engage the first engagement surface to selectively couple the motor and the pulley.

6. A device as in claim 2, further comprising a gear assembly coupling the motor and the pulley with each other.

7. A device as in claim 2, wherein the controller is configured to rotate the motor in the retraction direction to retract a portion of the seatbelt onto the pulley when an impact event is detected.

8. A device as in claim 7, further comprising a sensor electrically connected with the controller and configured to detect the impact event.

9. A device as in claim 1, wherein the seatbelt positioning device is a seatbelt buckle coupled with the seatbelt such that the rotation of the motor in the protraction direction protracts the seatbelt buckle and the portion of the seatbelt away from the motor.

10. A device as in claim 1, wherein the measurement device is a load sensor.

11. A device as in claim 10, wherein the system input is a belt load acting on the seatbelt.

12. A device as in claim 1, wherein the measurement device is a timer.

13. A device as in claim 12, wherein the system input is a time elapsed after an impact event is detected.

14. A device for controlling tension of a vehicle seatbelt that is coupled with a vehicle seat, the device comprising:
a seatbelt positioning device coupled with the seatbelt such that movement of the seatbelt positioning device moves at least a portion of the seatbelt with respect to the vehicle seat;
a first tension controlling device configured to move the seatbelt positioning device in a protraction direction and protract the portion of the seatbelt with respect to the vehicle seat when a system input reaches a maximum desired level; and
a second tension controlling device selectively coupling the first tension controlling device with the seatbelt positioning device, wherein the second tension controlling device is configured to decouple the first tension controlling device and the seatbelt positioning device from each other when a belt load acting on the seatbelt reaches a critical level.

15. A device as in claim 14, wherein the seatbelt positioning device is a pulley coupled with the seatbelt such that rotation of the pulley in the protraction direction protracts the seatbelt from the pulley.

16. A device as in claim 14, wherein the system input is the belt load acting on the seatbelt.

17. A device as in claim 14, wherein the system input is a time elapsed after a vehicle impact is detected.

18. A device as in claim 14, wherein the first tension controlling device includes a motor coupled with the pulley such as to rotate the pulley in the protraction direction.

19. A device as in claim 18, wherein the first tension controlling device further includes a controller electrically connected to the motor such as to rotate the pulley in the protraction direction when the system input reaches the maximum desired level

20. A device as in claim 19, wherein the second tension controlling device is a tension limiting device selectively coupling the motor with the pulley, wherein the tension limiting device is configured to decouple the motor and the pulley from each other when the belt load acting on the seatbelt reaches the critical level.

21. A device as in claim 20, wherein the tension limiting device includes a torsion bar having a first end coupled with the motor and a second end coupled with the pulley, and wherein the torsion bar has a torsional yield limit corresponding to the critical level.

22. A method of controlling tension of a vehicle seatbelt, comprising:
coupling a pulley with the seatbelt such that rotation of the pulley moves the seatbelt;
coupling a motor with the pulley such that rotation of the motor in a protraction direction protracts the seatbelt from the pulley; and
controlling the motor with a controller to rotate the motor in the protraction direction and to protract a portion of the seatbelt from the pulley when a system input reaches a maximum desired level.

23. A method as in claim 22, further comprising measuring a tension acting on the seatbelt with a load sensor.

24. A method as in claim 23, wherein the system input is the belt load acting on the seatbelt.

25. A method as in claim 23, wherein the system input is a time elapsed after a vehicle impact is detected.

26. A method as in claim 22, further comprising selectively coupling the motor and the pulley with each other with a tension limiting device configured to decouple the motor and the pulley from each other when a tension acting on the seatbelt reaches a critical belt load level.

27. A method as in claim 26, wherein the step of selectively coupling the motor and the pulley with each other includes coupling a first end of a torsion bar with the motor and coupling a second end of the torsion bar with the pulley.
